(19) United States
(12) Patent Application Publication
(10) Pub. No.: US 2026/0175673 A1
(43) Pub. Date: Jun. 25, 2026

(54) COOLING MODULE FOR A MOTOR VEHICLE

(71) Applicant: VALEO SYSTEMES THERMIQUES, La Verriere (FR)

(72) Inventors: Remi TOURNOIS, La Verriere (FR); Sebastien RIVIERE, La Verriere (FR); Daniel DANETZKI, Bad Rodach (DE)

(73) Assignee: VALEO SYSTEMES THERMIQUES, La Verriere (FR)

(21) Appl. No.: 18/833,200

(22) PCT Filed: Dec. 8, 2022
(86) PCT No.: PCT/EP2022/084990

§ 371 Date: Jul. 25, 2024

(30) Foreign Application Priority Data
Jan. 25, 2022 (FR) FR2200615

(51) Int. Cl. B60K 11/08; B60K 1/00; B60K 11/04

(52) U.S. Cl. CPC B60K 11/08; B60K 11/04; B60K 2001/005

(57) ABSTRACT

The invention relates to a cooling module for a motor vehicle, including: a ventilation duct, a support frame configured to allow the fastening of at least one heat exchanger and/or of a motor-fan unit, the support frame having two lateral walls and two transverse walls defining an open frame, the support frame also having a front end face arranged to face a rear end face of the ventilation duct, a seal placed between the ventilation duct and the support frame, the seal bearing on at least one of the transverse walls of the support frame.

### TECHNICAL FIELD

The field of the present invention is that of cooling modules for motor vehicles, and more particularly sealing devices intended for heat exchange systems of motor vehicles, in particular hybrid or electric vehicles.

### BACKGROUND OF THE INVENTION

It is known to provide, in motor vehicles, various circuits for refrigerant or heat transfer fluid, in order to cool various components of the vehicle and in particular the engine or the batteries, and/or to form a cooling circuit of a heating, air conditioning and/or ventilation system. These various fluid circuits are brought to pass through one or more heat exchangers with which the vehicle is equipped, in particular on the front face of the vehicle, such that the fluid circulating in the exchanger can exchange heat with a stream of air entering through the front face of the vehicle.

Such systems are implemented both for vehicles with a combustion engine and for electric or hybrid vehicles. In electric or hybrid vehicles, the current electric drive means make use of increasingly powerful batteries to improve the drive and comfort performance of the vehicle, while at the same time increasing the range of the vehicle. The increase in the power of the batteries has to be accompanied by research into rapid charging means. Rapid charging terminals that implement electrical powers greater than 50 kW are known. Such powers are nevertheless accompanied by heat dissipation in the battery of the vehicle, which, if it not evacuated, can cause irreversible damage thereto such as a reduction in its lifespan or a limitation of its charging speed.

In order to prevent such damage, it is necessary to thermoregulate the batteries, and in particular to cool them. For this purpose, motor vehicles are conventionally equipped with heat exchange systems capable of transferring heat energy from one fluid to another. A ventilation duct makes it possible to guide the incoming air, which is cold, towards one or more heat exchangers, which can be arranged in a hermetically sealed encapsulation casing that also encapsulates a motor-fan unit.

In the example of specific rapid charging conditions, the vehicle is stationary. In order to ensure a flow of air that is sufficient to allow optimal cooling of the battery, the motor-fan unit operates at high speeds, thereby generating a high overpressure within the casing. Such an overpressure is liable to cause both the leakage of fresh air, i.e. the passage of air out of the casing without passing through the one or more exchangers, and, where appropriate, recirculation of hot air coming from outside the casing, and this has the effect of reducing the thermal performance.

In another example corresponding to the case in which the vehicle is at high speed, the substantial flow of air entering through the ventilation duct can cause air leaks leading to a decrease in the stream of air passing through the exchangers and therefore a drop in technical performance.

In order to remedy these drawbacks, at least partially, sealing devices can be put in place in the encapsulation casing.

### SUMMARY OF THE INVENTION

The present invention relates to a cooling module for a motor vehicle, comprising a ventilation duct, a support frame configured to allow the fastening of at least one heat exchanger and/or of a motor-fan unit, said support frame having two lateral walls and two transverse walls defining an open frame, said support frame also having a front end face arranged to face a rear end face of the ventilation duct, a seal placed between the ventilation duct and the support frame, said seal bearing on at least one of the transverse walls of the support frame.

Such a configuration makes it possible to ensure good sealing between the ventilation duct and the support frame while at the same time ensuring correct positioning during the process of assembling the cooling module. The seal contributes to preventing air leaks, even in the event of vibrations or translational movements of one of the components of the module.

According to one aspect of the invention, at least one of the transverse walls of the support frame has a first portion that is substantially planar, bearing on the exchanger and/or the motor-fan unit, and a second portion having an L-shaped profile, this second portion being configured to bear against the seal so as to ensure the sealing between the support frame and the ventilation duct.

According to one aspect of the invention, the seal is in the form of a rectangular parallelepiped, which comprises four substantially planar walls.

According to one aspect of the invention, at least the upper wall of the seal has a folded zone, which is arranged to bear against the second portion of the transverse wall.

According to one aspect of the invention, the L-shaped profile has a first surface and a second surface, said first and second surfaces being perpendicular to one another so as to form the L shape of the profile, the folded zone of the seal bearing simultaneously on the first surface and the second surface.

The L shape of the profile ensures the correct positioning of the seal during assembly of the cooling module. It makes it possible to lock said seal in place and to improve the sealing of the module over the entire life of the motor vehicle, even in the event of strong vibrations or in the event of translational movements of one or more components.

According to one aspect of the invention, the lower wall of the seal has a folded zone, which is arranged to bear against the second portion of the transverse wall.

The L shape of the profile makes it possible to ensure better compression and therefore better sealing. The embodiment in which the seal has folded zones both on its upper wall and on its lower wall makes it possible to further improve this effect.

According to one aspect of the invention, the seal is formed from an elastically deformable material.

The use of a deformable material makes it easier to insert the seal into the L-shaped profile of the support frame. Better compression can also be obtained and would thus make it possible to obtain better sealing of the cooling module.

According to one aspect of the invention, the deformable material is EPDM.

According to one aspect of the invention, the seal is overmolded on the rear end face of the ventilation duct.

According to one aspect of the invention, the seal is clip-fastened onto the rear end face of the ventilation duct.

According to one aspect of the invention, the seal is screwed onto the rear end face of the ventilation duct.

The invention also relates to a heat exchange system for a motor vehicle, comprising a cooling module according to the invention and wherein the support frame is formed by two lateral cheeks of the exchanger, which form the transverse walls, the two lateral walls being formed by the two header tanks of said exchanger.

Another subject of the invention is a heat exchange system for a motor vehicle, comprising a cooling module according to the invention and wherein the support frame is formed by the nozzle of the motor-fan unit.

### BRIEF DESCRIPTION OF THE DRAWINGS

Further features, details and advantages of the invention will become more clearly apparent upon reading the description given below by way of indication with reference to drawings, in which:

FIG. 1 is a schematic perspective view of a cooling module according to the invention, a seal being placed between a support frame and a ventilation duct;

FIG. 2 is a schematic perspective view of a ventilation duct and a seal according to the invention;

FIG. 3 is a schematic perspective view of an exchanger, the support frame according to the invention being formed of the lateral cheeks and the header tanks of said exchanger;

FIG. 4 is a schematic perspective view of a motor-fan unit, the support frame being formed by the nozzle of said motor-fan unit;

FIG. 5 is a view in cross section of a seal according to the invention in position in the support frame in FIG. 1;

FIG. 6 is a schematic perspective view of the seal according to FIG. 1 or 2;

FIG. 7 is a schematic view of a wall of the support frame in one of FIGS. 1 to 4; and

FIG. 8 is a view in cross section of the seal in FIG. 6 before positioning in the support frame.

### DETAILED DESCRIPTION OF THE INVENTION

The features, variants and various embodiments of the invention can be combined with one another, in various combinations, as long as they are not mutually incompatible or mutually exclusive. It will be possible, in particular, to imagine variants of the invention that comprise only a selection of the features described below, in isolation from the other features described, if this selection of features is sufficient to confer a technical advantage and/or to distinguish the invention from the prior art.

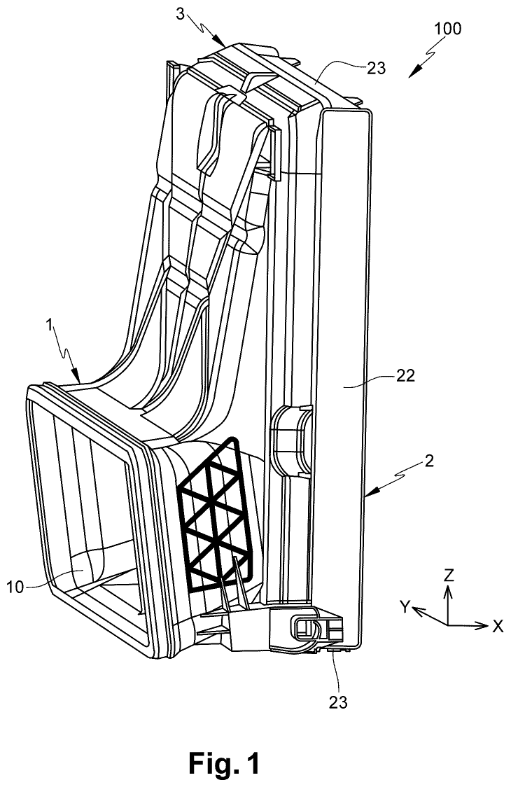

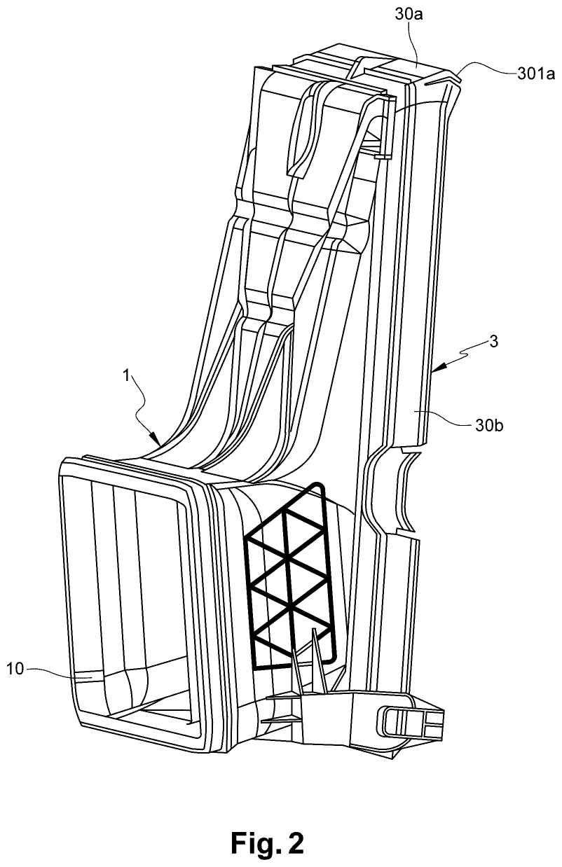

With reference to FIGS. 1 and 2, a cooling module 100 according to the invention, which is for example intended to be placed on the front face of a motor vehicle, comprises an air inlet or ventilation duct 1, a support frame 2 in which there can be received at least one exchanger 4 and/or a motor-fan unit 5 (which are not visible in FIG. 1). The cooling module 100 also has a seal 3 placed between the ventilation duct 1 and the support frame 2.

In the cooling module 100, the ventilation duct 1 is configured to convey, towards the one or more exchangers 4, cooling air, which is for example collected outside the motor vehicle equipped with the cooling module 100, for example at a front grille of such a motor vehicle.

The ventilation duct 1 has an aeration opening 10 that is open on the front face of the motor vehicle, thus allowing the entry of a fresh air stream that it redirects in the module 100, towards the heat exchanger 4. This ventilation duct 1 has, at an end opposite the aeration opening, a rear end face (not visible), brought to face, in the closed configuration illustrated in FIG. 1, the support frame 2.

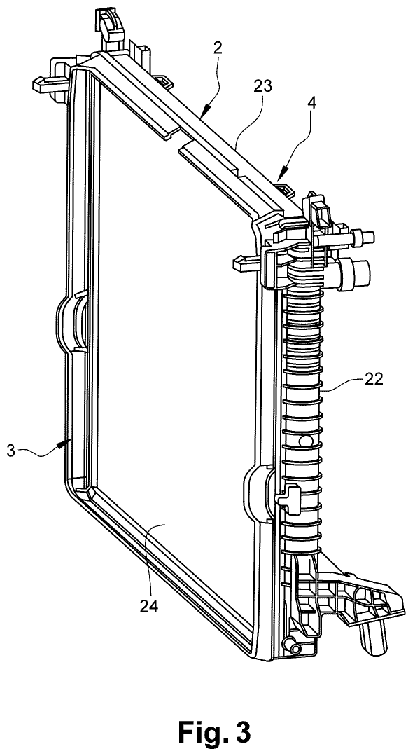

In FIG. 1, the support frame 2 has two lateral walls 22 and two transverse walls 23, which define an open frame making it possible to house, between the walls, one or more heat exchangers 4 (depicted in FIG. 3) and/or the motor-fan unit 5 (depicted in FIG. 4). In FIGS. 3 and 4, a front end face 24 of the support frame 2 is defined as being the face intended to face the ventilation duct 1, and more particularly to face the rear end face of this ventilation duct 1. It is through this front end face 24 that, in the example illustrated, the fresh air is brought to enter the frame 1 so as to pass through the one or more exchangers 4.

As indicated above, FIG. 3 depicts the case in which the support frame 2 is formed by components of the exchanger 4. In the present case, the transverse walls 23 are formed by the lateral cheeks of the exchanger 4, while the lateral walls 22 are, for example, formed by the header tanks of said exchanger 4. Thus, during assembly of the cooling module 100, the seal 3 bears directly on the exchanger 4 in order to realize the sealing.

In the same way, FIG. 4 depicts an alternative embodiment in which the support frame 2 is formed by the nozzle of the motor-fan unit 5. Thus, during assembly of the module 100, the seal 3 comes directly into contact with the nozzle of the motor-fan unit. This embodiment is particularly advantageous when the motor-fan unit is placed upstream of the heat exchangers with respect to the direction of the air.

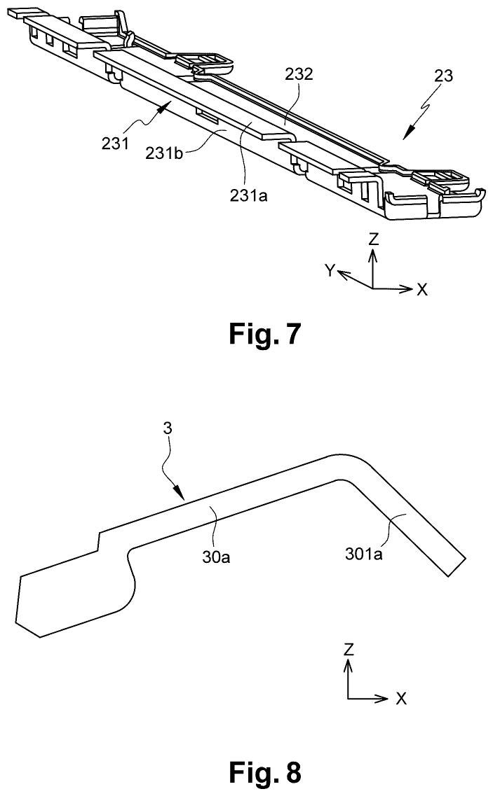

FIG. 7 depicts at least one of the transverse walls 23 of the support frame 2, which has a substantially planar first portion 232. In the embodiment corresponding to the exchanger 4, this wall is depicted by one of the lateral cheeks of the exchanger, while in the embodiment corresponding to the motor-fan unit, the wall 23 is formed by the upper wall of the nozzle. This wall 23 also has a second portion 231 having an L-shaped profile. This second portion 231 is configured to bear against the seal 3 so as to ensure the sealing between the support frame 2 and the ventilation duct 1. The L-shaped profile forming the second portion 231 has a first surface 231a extending in the direction of the X axis and a second surface 231b extending in the direction of the Z axis. In order to form the L-shaped profile, the first surface 231a is perpendicular to the second surface 231b.

As specified above, the ventilation duct 1 has a seal 3 added to its rear end. In the figures and more specifically in FIG. 6, an exemplary embodiment of the seal 3 is depicted. This can, for example, have four walls, respectively 30a, 30b, 30c, 30d, which are substantially planar, which form a rectangular parallelepiped of which the main rectangular shape extends in the direction of a main plane of the seal 3. The long sides of the rectangular shape, which are constituted by the upper wall 30a and the lower wall 30c parallel to this upper wall 30a, extend mainly in the direction of the width of the seal, i.e. in the direction of the transverse axis Y. The short sides of the rectangular shape, which are constituted respectively by the lateral walls 30b and 30d, which are parallel to each other and perpendicular to the upper wall 30a and lower wall 30c, extend mainly in the direction of the height of the seal 3, i.e. in the direction of the vertical axis Z.

The seal 3 can also be made up of only a limited number of walls. For example, it would be possible to have an embodiment having only the upper wall 30a and lower wall 30c.

The seal 3 is connected to the ventilation duct 1 and bears against the support frame 2 during installation of the cooling module 100.

In one of the embodiments, the seal 3 is overmolded on the ventilation duct 1 during an additional process step. This embodiment has the advantage of improving the sealing and simplifying the manufacturing process by limiting the additional steps. In this embodiment, the gasket 3 is overmolded on the rear face of the ventilation duct 1.

However, in alternative cases, the seal 3 can be manufactured separately and subsequently attached to the ventilation duct 1. It can thus be clip-fastened or else screwed onto the rear face of the ventilation duct before the assembly of the cooling module 100.

The seal 3 is preferably manufactured from an elastically deformable material, thus making it possible to simplify the assembly of the cooling module 100. This material is chosen from deformable polymers such as for example an elastomer, a rubber, etc. It is preferably manufactured from EPDM.

FIGS. 6 and 8 show a folded zone 301a of the upper wall 30a of the seal 3. However, the lower wall 30c and the lateral walls 30b and 30d could have an identical configuration. Thus, FIG. 6 illustrates the embodiment in which the upper wall 30a has a folded zone 301a and the lower wall 30c has a folded zone 301c. The mode of operation will be the same regardless of the number of walls equipped with such zones.

The wall 30a thus has a folded zone 301a when the cooling module 100 is not yet assembled. The folded zone 301a is arranged to bear against the support frame 2 during installation and thus allow the sealing of the module 100.

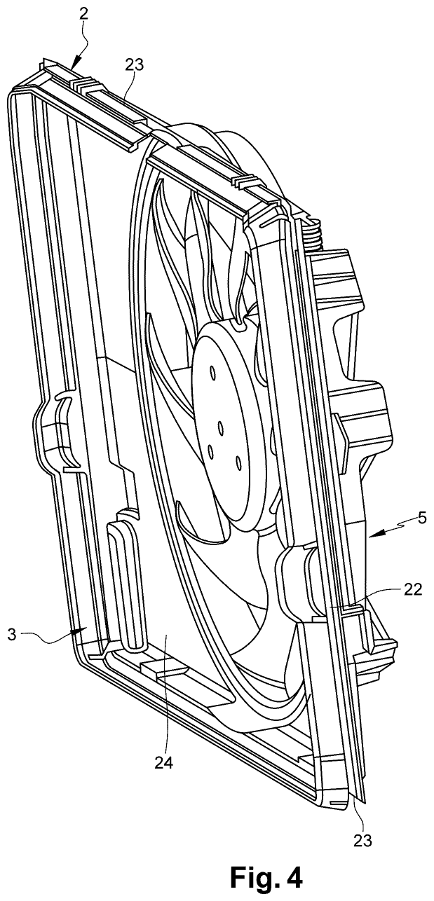

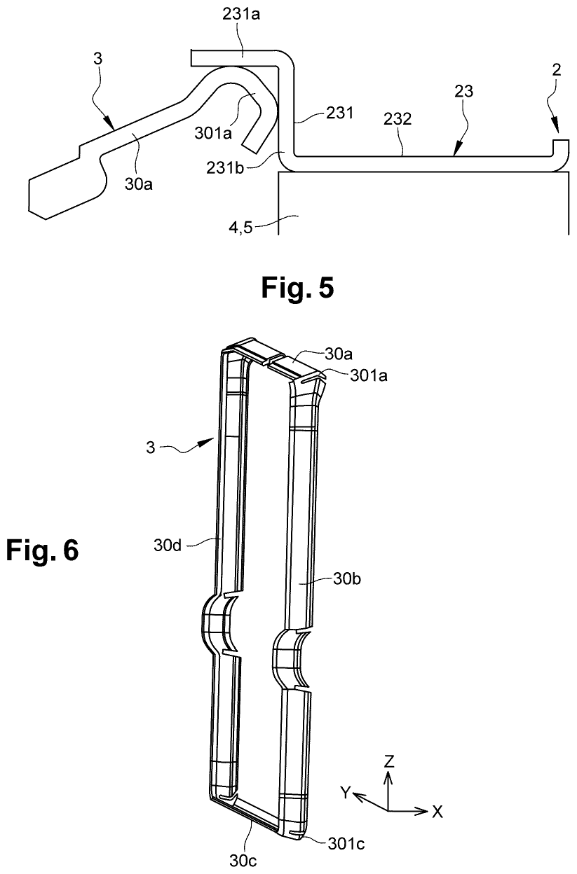

As depicted in FIG. 5, which illustrates the configuration of the seal 3 once it has been positioned and when the cooling module is installed, the folded zone 301a bears on the second portion 231 of the transverse wall 23 of the support frame 2. Specifically, as shown in FIG. 5, the folded zone 301a of the seal 3 bears simultaneously on the first surface 231a and the second surface 231b of the L-shaped profile described above.

1. A cooling module for a motor vehicle, comprising:
a ventilation duct,
a support frame configured to allow fastening of at least one heat exchanger or of a motor-fan unit, said support frame having two lateral walls and two transverse walls defining an open frame, said support frame also having a front end face arranged to face a rear end face of the ventilation duct,
a seal placed between the ventilation duct and the support frame, said seal bearing on at least one of the two transverse walls of the support frame.

2. The cooling module according to claim 1, wherein at least one of the two transverse walls of the support frame has
a first portion that is substantially planar, configured to bear on the at least one heat exchanger or the motor-fan unit,
a second portion having an L-shaped profile, this second portion being configured to bear against the seal so as to ensure sealing between the support frame and the ventilation duct.

3. The cooling module according to claim 1, wherein the seal is in form of a rectangular parallelepiped, which includes four substantially planar walls, including an upper wall and a lower wall.

4. The cooling module according to claim 3, wherein at least the upper wall of the seal has an upper folded zone, which is arranged to bear against the second portion of the at least one of the two transverse walls.

5. The cooling module according to claim 4, wherein the L-shaped profile has a first surface and a second surface, said first and second surfaces being perpendicular to one another so as to form the L shape of the profile, the folded zone of the seal bearing simultaneously on the first surface and the second surface.

6. The cooling module according to claim 3, wherein the lower wall of the seal has folded lower folded zone, which is arranged to bear against the second portion of the at least one of the two transverse wall.

7. The cooling module according to claim 1, wherein the seal is formed from an elastically deformable material.

8. The cooling module according to claim 1, wherein the seal is overmolded on the rear end face of the ventilation duct.

9. A heat exchange system for a motor vehicle, comprising a cooling module having
at least one heat exchanger with two header tanks,
a ventilation duct,
a support frame configured to allow fastening of the at least one heat exchanger, said support frame having two lateral walls and two transverse walls defining an open frame, said support frame also having a front end face arranged to face a rear end face of the ventilation duct,
a seal placed between the ventilation duct and the support frame, said seal bearing on at least one of the two transverse walls of the support frame,
wherein the support frame is formed by two lateral cheeks of the at least one heat exchanger, which form the two transverse walls, the two lateral walls being formed by the two header tanks of said at least one heat exchanger.

10. A heat exchange system for a motor vehicle, comprising a cooling module having
a motor-fan unit with a nozzle,
a ventilation duct,
a support frame configured to allow fastening of the motor-fan unit, said support frame having two lateral walls and two transverse walls defining an open frame, said support frame also having a front end face arranged to face a rear end face of the ventilation duct,
a seal placed between the ventilation duct and the support frame, said seal bearing on at least one of the two transverse walls of the support frame
wherein the support frame is formed by the nozzle of the motor-fan unit.

11. The cooling module according to claim 1, wherein the seal is formed from EPDM.
